(19) United States
(12) Patent Application Publication
(10) Pub. No.: US 2026/0343237 A1
(43) Pub. Date: Oct. 29, 2026

(54) SITUATION AWARENESS PROCESSING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Yuxin MAO, Beijing (CN); Yang SHEN, Beijing (CN); Jinhua WU, Beijing (CN)

(73) Assignee: Beijing Xiaomi Mobile Software Co., Ltd., Beijing (CN)

(21) Appl. No.: 19/103,976

(22) PCT Filed: Aug. 17, 2022
(86) PCT No.: PCT/CN2022/113141

§ 371 Date: Feb. 14, 2025

(51) Int. Cl. H04W 12/122; H04W 12/08

(52) U.S. Cl. CPC H04W 12/122; H04W 12/08

(57) ABSTRACT

A situation awareness processing method includes receiving situation awareness information sent by a predetermined object, determining, based on the situation awareness information, an Internet of Things (IoT) device that is at least one of being intruded or abnormal, and sending first indication information to a second network function, where the first indication information is used for indicating the IoT device as an IoT device that is at least one of being intruded or abnormal.

### CROSS-REFERENCE TO RELATED APPLICATION

The present application is a U.S. National Stage of International Application No. PCT/CN2022/113141, filed on Aug. 17, 2022, the entire content of which is incorporated herein by reference for all purposes.

### TECHNICAL FIELD

The present disclosure relates to, but is not limited to, the field of wireless communication technology and, in particular, relates to a situation awareness processing method and apparatus, a communication device, and a storage medium.

### BACKGROUND

Internet of Things (IoT) refers to connecting any object to a network via an information sensing device in accordance with a protocol, where objects perform information exchange and communication through information media to realize functions such as intelligent identification, positioning, tracking, and supervision. Data analysis refers to performing, by using appropriate statistical analysis methods, analyzing, summarizing, understanding, and digesting on large amounts of collected data to maximize the function and usefulness of the data. Data analysis is the process of extracting useful information and forming conclusions by performing studying and summarizing on data in detail.

### SUMMARY

Embodiments of the present disclosure disclose a situation awareness processing method and apparatus, a communication device, and a storage medium.

According to a first aspect of the embodiments of the present disclosure, there is provided a situation awareness processing method, where the method is performed by a first network function, and the method includes:
receiving situation awareness information sent by a predetermined object;
determining, based on the situation awareness information, an IoT device that is intruded and/or abnormal; and
sending first indication information to a second network function, where the first indication information is used for indicating the IoT device as an IoT device that is intruded and/or abnormal.

According to a second aspect of the embodiments of the present disclosure, there is provided a situation awareness processing method, where the method is performed by a first network function, and the method includes:
receiving situation awareness information sent by a predetermined object;
determining, based on the situation awareness information, an IoT device that is intruded and/or abnormal; and
sending second indication information to an application function (AF), where the second indication information is used for indicating the IoT device as an IoT device that is intruded and/or abnormal.

According to a third aspect of the embodiments of the present disclosure, there is provided a situation awareness processing method, where the method is performed by a predetermined object, and the method includes:
sending situation awareness information to a first network function, where the situation awareness information is used for determining an IoT device that is intruded and/or abnormal.

According to a fourth aspect of the embodiments of the present disclosure, there is provided a situation awareness processing method, where the method is performed by a second network function, and the method includes:
receiving first indication information sent by a first network function, where the first indication information is used for indicating an IoT device as a device that is intruded and/or abnormal; and
sending third indication information to a third network function, where the third indication information is used for indicating the IoT device as the device that is intruded and/or abnormal.

According to a fifth aspect of the embodiments of the present disclosure, there is provided a situation awareness processing method, where the method is performed by a third network function, and the method includes:
receiving third indication information sent by a second network function, where the third indication information is used for indicating an IoT device as a device that is intruded and/or abnormal.

According to a sixth aspect of the embodiments of the present disclosure, there is provided a situation awareness processing method, where the method is performed by an AF, and the method includes:
receiving second indication information sent by a first network function, where the second indication information is used for indicating an IoT device as a device that is intruded and/or abnormal.

According to a seventh aspect of the embodiments of the present disclosure, there is provided a situation awareness processing system, where the system includes a first network function, a second network function and a third network function. The first network function performs the method as performed by any first network function of the present disclosure; the second network function performs the method as performed by any second network function of the present disclosure; and the third network function performs the method as performed by any third network function of the present disclosure.

According to an eighth aspect of the embodiments of the present disclosure, there is provided a communication device, where the communication device includes:
a processor; and
a memory, configured to store an executable instruction of the processor; where
the processor, when running the executable instruction, is configured to implement the method according to any embodiment of the present disclosure.

According to a ninth aspect of the embodiments of the present disclosure, there is provided a computer storage medium, where the computer storage medium stores a computer-executable instruction, and the executable instruction, when executed by a processor, implements the method according to any embodiment of the present disclosure.

### BRIEF DESCRIPTION OF THE DRAWINGS

FIG. 1 is a schematic diagram of a structure of a wireless communication system illustrated according to an exemplary embodiment.

FIG. 2 is a schematic diagram of an architecture for situation awareness illustrated according to an exemplary embodiment.

FIG. 3 is a schematic flow diagram of a situation awareness processing method illustrated according to an exemplary embodiment.

FIG. 4 is a schematic flow diagram of a situation awareness processing method illustrated according to an exemplary embodiment.

FIG. 5 is a schematic flow diagram of a situation awareness processing method illustrated according to an exemplary embodiment.

FIG. 6 is a schematic flow diagram of a situation awareness processing method illustrated according to an exemplary embodiment.

FIG. 7 is a schematic flow diagram of a situation awareness processing method illustrated according to an exemplary embodiment.

FIG. 8 is a schematic flow diagram of a situation awareness processing method illustrated according to an exemplary embodiment.

FIG. 9 is a schematic flow diagram of a situation awareness processing method illustrated according to an exemplary embodiment.

FIG. 10 is a schematic flow diagram of a situation awareness processing method illustrated according to an exemplary embodiment.

FIG. 11 is a schematic flow diagram of a situation awareness processing method illustrated according to an exemplary embodiment.

FIG. 12 is a schematic flow diagram of a situation awareness processing method illustrated according to an exemplary embodiment.

FIG. 13 is a schematic flow diagram of a situation awareness processing method illustrated according to an exemplary embodiment.

FIG. 14 is a schematic flow diagram of a situation awareness processing method illustrated according to an exemplary embodiment.

FIG. 15 is a schematic flow diagram of a situation awareness processing method illustrated according to an exemplary embodiment.

FIG. 16 is a schematic flow diagram of a situation awareness processing method illustrated according to an exemplary embodiment.

FIG. 17 is a schematic flow diagram of a situation awareness processing method illustrated according to an exemplary embodiment.

FIG. 18 is a schematic flow diagram of a situation awareness processing method illustrated according to an exemplary embodiment.

FIG. 19 is a schematic diagram of a situation awareness processing system illustrated according to an exemplary embodiment.

FIG. 20 is a schematic diagram of a situation awareness processing apparatus illustrated according to an exemplary embodiment.

FIG. 21 is a schematic diagram of a situation awareness processing apparatus illustrated according to an exemplary embodiment.

FIG. 22 is a schematic diagram of a situation awareness processing apparatus illustrated according to an exemplary embodiment.

FIG. 23 is a schematic diagram of a situation awareness processing apparatus illustrated according to an exemplary embodiment.

FIG. 24 is a schematic diagram of a situation awareness processing apparatus illustrated according to an exemplary embodiment.

FIG. 25 is a schematic diagram of a situation awareness processing apparatus illustrated according to an exemplary embodiment.

FIG. 26 is a schematic diagram of a structure of a terminal illustrated according to an exemplary embodiment.

FIG. 27 is a block diagram of a base station illustrated according to an exemplary embodiment.

### DETAILED DESCRIPTION

The exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present disclosure. On the contrary, they are only examples of devices and methods consistent with some aspects of the embodiments of the present disclosure.

The terms used in the embodiments of the present disclosure are used solely for the purpose of describing particular embodiments, but are not intended to limit the embodiments of the present disclosure. The singular forms of “a” and “the” used in the embodiments of the present disclosure and the appended claims are also intended to include the plural form, unless the context clearly indicates other meanings. It should also be understood that the term “and/or” as used in this article refers to and includes any or all possible combinations of one or more of the associated listed items.

It should be understood that although the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at the time of . . . ”, “when . . . ”, or “in response to determining”.

For the purposes of brevity and ease of understanding, the terms used in this article to characterize magnitude relationships are “greater than” or “less than”. However, for those skilled in the art, it can be understood that the term “greater than” also covers the meaning of “greater than or equal to”, and “less than” also covers the meaning of “less than or equal to”.

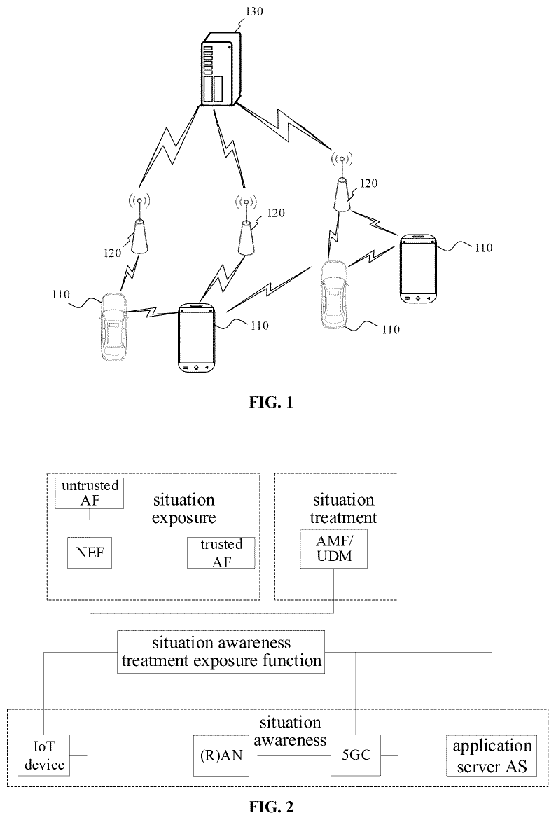

Referring to FIG. 1, a schematic diagram of a structure of a wireless communication system provided in an embodiment of the present disclosure is shown. As shown in FIG. 1, the wireless communication system is a communication system based on the mobile communication technology, and the wireless communication system may include one or more user devices 110, and one or more base stations 120.

In some embodiments, the user device 110 may refer to a device that provides voice and/or data connectivity to a user. The user device 110 may communicate with one or more core networks via a radio access network (RAN). The user device 110 may be an IoT user device, such as a sensor device, a mobile phone, or a computer with an IoT user device. For example, the user device 110 may be a fixed, portable, pocket, handheld, computer built-in, or vehicle-mounted device. For example, the user device 110 may be a station (STA), a subscriber unit, a subscriber station, a mobile station, a mobile, a remote station, an access point, a remote user device (remote terminal), an access user device (access terminal), a user terminal, a user agent, a user device, or a user equipment. Or, the user device 110 may be a device of an unmanned aerial vehicle. Or, the user device 110 may be a vehicle-mounted device, such as a trip computer with wireless communication functions, or a wireless user device externally connected to a trip computer. Or, the user device 110 may be a road side device, such as a street light, a signal light, or other road side devices with wireless communication functions.

The base station 120 may be a network side device in the wireless communication system. In some embodiments, the wireless communication system may be the 4th generation mobile communication (4G) system, also referred to as the long term evolution (LTE) system. Or, the wireless communication system may be a 5G system, also referred to as a new radio (NR) system or a 5G NR system. Or, the wireless communication system may be a next generation system of the 5G system. In some embodiments, the access network in the 5G system may be referred to as a new generation-radio access network (NG-RAN).

In some embodiments, the base station 120 may be an evolved base station (eNB) used in a 4G system. Or, the base station 120 may be a base station (gNB) with a centralized distributed architecture in a 5G system. When adopting the centralized distributed architecture, the base station 120 typically includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a protocol stack of a physical (PHY) layer. The embodiments of the present disclosure do not limit the specific implementations of the base station 120.

A wireless connection may be established between the base station 120 and the user device 110 via a wireless air interface. In a different embodiment, the wireless air interface is a wireless air interface based on a 4G standard. Or, the wireless air interface is a wireless air interface based on a 5G standard, for example, the wireless air interface is a new air interface. Or, the wireless air interface may also be a wireless air interface based on a next generation mobile communication network technology standard of the 5G.

In some embodiments, an end to end (E2E) connection may also be established between user devices 110, for example, scenarios such as vehicle to vehicle (V2V) communication, vehicle to infrastructure (V2I) communication, and vehicle to pedestrian (V2P) communication in the vehicle to everything (V2X) communication.

Herein, the above-described user device may be considered as the terminal device in the following embodiments.

In some embodiments, the above-described wireless communication system may further include a network management device 130.

One or more base stations 120 are connected to the network management device 130 respectively. In some embodiments, the network management device 130 may be a core network device in the wireless communication system, for example, the network management device 130 may be a mobility management entity (MME) in the evolved packet core (EPC). Alternatively, the network management device may also be other core network devices, such as a service gateway (SGW), a public data network gateway (PGW), a policy and charging rules function (PCRF), or a home subscriber server (HSS). The implementation forms of the network management device 130 are not limited in the embodiments of the present disclosure.

In order to facilitate the understanding of those skilled in the art, the embodiments of the present disclosure enumerate a plurality of embodiments to provide a clear description of the technical solutions of the embodiments of the present disclosure. Of course, those skilled in the art can understand that the plurality of embodiments provided by the embodiments of the present disclosure may be performed individually or in combination with the methods of other embodiments in the embodiments of the present disclosure, or may be performed individually or in combination with some methods of other related arts. The embodiments of the present disclosure do not limit this.

An IoT device may perform an abnormal behavior, such as being misused or hijacked by a malicious application program or being stolen. In related arts, there is no solution in mobile networks to automatically identify a specific IoT device with an abnormal behavior, which poses a security risk to the IoT network. In order to better understand the technical solution described in any of the embodiments of the present disclosure, application scenarios are firstly described.

In an embodiment, referring to FIG. 2, an IoT device management architecture based on data analysis may include three parts, i.e., a situation exposure, a situation treatment, and a situation awareness. In some embodiments, the situation exposure part may include an untrusted AF, a network exposure function (NEF), and a trusted AF. The situation treatment part includes an AMF and a UDM. The situation awareness part includes an IoT device, a radio access network, a core network, and an application server. It should be noted that a situation awareness treatment exposure function (SATE) is newly added by the embodiments of the present disclosure.

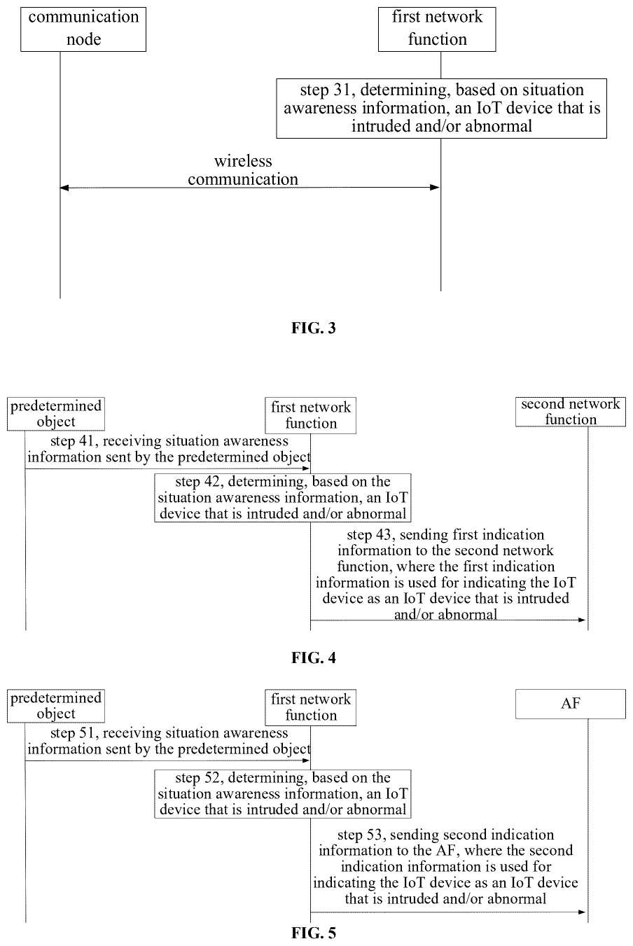

As shown in FIG. 3, a situation awareness processing method is provided in this embodiment, where the method is performed by a first network function, and the method includes step 31.

At step 31, an IoT device that is intruded and/or abnormal is determined based on situation awareness information.

Herein, the IoT device involved in the present disclosure may be a terminal. The terminal may be, but is not limited to, a mobile phone, a wearable device, a vehicle-mounted terminal, a road side unit (RSU), a smart home terminal, an industrial sensing device, and/or a medical device, etc. In some embodiments, the terminal may be a reduced capability (Redcap) terminal or an NR terminal (e.g., an NR terminal of R17) of a predetermined release.

The access network involved in the present disclosure may include a base station. The base station may be of various types, e.g., a base station of a third generation mobile communication (3G) network, a base station of a fourth generation mobile communication (4G) network, a base station of a fifth generation mobile communication (5G) network, or other evolved base stations.

The network element involved in the present disclosure may be an AMF, a UDM, and an NEF, etc. The first network function may be an SATE, the second network function may be a UDM, and the third network function may be an AMF. It should be noted that the network elements are not limited to the above examples. Exemplarily, the first network function may be any network element with a situation awareness treatment exposure function. In some embodiments of the present disclosure, the network element with the situation awareness treatment exposure function may be deployed as a communication node individually, or may be deployed uniformly within an existing network element. In short, a network element with the situation awareness treatment exposure function may be understood as a logical node that can be flexibly deployed in a network, which is not limited herein.

It should be noted that the IoT device being intruded may be that the IoT device is controlled by an illegal device. The IoT device being abnormal may be that a function of the IoT device is abnormal.

In an embodiment, the situation awareness information sent by a predetermined object is received, where the predetermined object includes at least one of the following: an IoT device, an access network (RAN) device, and a core network (CN) device; an IoT device that is intruded and/or abnormal is determined based on the situation awareness information; and first indication information is sent to a second network function, where the first indication information is used for indicating the IoT device as an IoT device that is intruded and/or abnormal, or, second indication information is sent to an AF, where the second indication information is used for indicating the IoT device as an IoT device that is intruded and/or abnormal.

In an embodiment, the situation awareness information that is obtained by the predetermined object based on situation awareness rule information and sent by the predetermined object is received. Based on the situation awareness information, the IoT device that is intruded and/or abnormal is determined. Herein, the situation awareness rule information may be pre-configured or may be sent by the first network function to the predetermined object according to a requirement. For example, the first network function may periodically send the situation awareness rule information to the predetermined object. It should be noted that the predetermined object may also periodically send the situation awareness information to the first network function.

In an embodiment, the situation awareness rule information is sent to the predetermined object, where the predetermined object includes at least one of the following: an IoT device, an access network (RAN) device, and a CN device. The situation awareness information that is obtained by the predetermined object based on the situation awareness rule information and sent by the predetermined object is received. The IoT device that is intruded and/or abnormal is determined based on the situation awareness information.

In an embodiment, the situation awareness information includes at least one of the following:
behavior information of an IoT device;
information for sending a data packet; and
information for receiving a data packet.

In some embodiments, the information for sending a data packet and/or the information for receiving a data packet may include a source Internet protocol (IP) address, a destination IP address, a time point for data transmission, a duration for data transmission, and a volume of the data packet, etc.

In an embodiment, the situation awareness rule information is periodically sent to the predetermined object, where the predetermined object includes at least one of the following: an IoT device, an access network (RAN) device, and a CN device. The situation awareness information that is obtained by the predetermined object based on the situation awareness rule information and sent by the predetermined object is received periodically. The IoT device that is intruded and/or abnormal is determined based on the situation awareness information.

In an embodiment, the IoT device that is intruded and/or abnormal is determined based on the situation awareness information. In response to determining the IoT device, the first indication information is sent to the second network function, where the first indication information is used for indicating the IoT device as an IoT device that is intruded and/or abnormal. Herein, the first indication information may be used for indicating a device identification (ID) of the IoT device.

In an embodiment, the IoT device that is intruded and/or abnormal is determined based on the situation awareness information. In response to determining the IoT device, the second indication information is sent to the AF, where the second indication information is used for indicating the IoT device as a device that is intruded and/or abnormal. Herein, the second indication information may be used for indicating at least one of the following: a time of the IoT device to attack a network, and an attack behavior of the IoT device when the IoT device attacks the network.

In the embodiments of the present disclosure, the situation awareness information sent by the predetermined object is received, where the predetermined object includes at least one of the following: an IoT device, an access network (RAN) device, and a CN device; the IoT device that is intruded and/or abnormal is determined based on the situation awareness information; and the first indication information is sent to the second network function, where the first indication information is used for indicating the IoT device as an IoT device that is intruded and/or abnormal, or, the second indication information is sent to the AF, where the second indication information is used for indicating the IoT device as an IoT device that is intruded and/or abnormal. Herein, since the first network function can determine, based on the situation awareness information obtained from the predetermined object, the intruded and/or abnormal IoT device, after the intruded and/or abnormal IoT device is determined, through sending by the first network function the first indication information to the second network function or sending by the first network function the second indication information to the AF, the second network function and/or the AF can perform a security disposal on the IoT device in a timely manner. Compared to the manner of not being capable of determining the IoT device in the IoT, the security of the IoT communication is improved, and the security risk due to the intrusion behavior and the abnormality of the IoT device is reduced.

It should be noted that those skilled in the art may understand that the methods provided in the embodiments of the present disclosure may be performed individually or in combination with some methods in the embodiments of the present disclosure or some methods in the related arts.

As shown in FIG. 4, a situation awareness processing method is provided in this embodiment, where the method is performed by a first network function, and the method includes steps 41 to 43.

At step 41, situation awareness information sent by a predetermined object is received.

At step 42, an IoT device that is intruded and/or abnormal is determined based on the situation awareness information.

At step 43, first indication information is sent to a second network function, where the first indication information is used for indicating the IoT device as an IoT device that is intruded and/or abnormal.

In an embodiment, the predetermined object includes at least one of the following: an IoT device, an access network (RAN) device, a CN device. Herein, the CN device may be a device in the core network capable of obtaining the situation awareness information.

In an embodiment, the first network function is an SATE. The second network function is a UDM.

In an embodiment, the situation awareness information includes at least one of the following:
behavior information of an IoT device;
information for sending a data packet;
information for receiving a data packet.

In an embodiment, situation awareness rule information is sent to the predetermined object. The situation awareness information that is obtained by the predetermined object based on the situation awareness rule information and sent by the predetermined object is received. The IoT device that is intruded and/or abnormal is determined based on the situation awareness information. The first indication information is sent to the second network function, where the first indication information is used for indicating the IoT device as an IoT device that is intruded and/or abnormal. In an embodiment, the first indication information may be further used for indicating a device ID of the IoT device.

It should be noted that those skilled in the art may understand that the methods provided in the embodiments of the present disclosure may be performed individually or in combination with some methods in the embodiments of the present disclosure or some methods in the related arts.

As shown in FIG. 5, a situation awareness processing method is provided in this embodiment, where the method is performed by a first network function, and the method includes steps 51 to 53.

At step 51, situation awareness information sent by a predetermined object is received.

At step 52, an IoT device that is intruded and/or abnormal is determined based on the situation awareness information.

At step 53, second indication information is sent to an AF, where the second indication information is used for indicating the IoT device as an IoT device that is intruded and/or abnormal.

In an embodiment, the predetermined object includes at least one of the following: an IoT device, an access network (RAN) device, a CN device. Herein, the CN device may be a device in the core network capable of obtaining the situation awareness information.

In an embodiment, the first network function is an SATE.

In an embodiment, the situation awareness information includes at least one of the following:
behavior information of an IoT device;
information for sending a data packet;
information for receiving a data packet.

In an embodiment, situation awareness rule information is sent to the predetermined object. The situation awareness information that is obtained by the predetermined object based on the situation awareness rule information and sent by the predetermined object is received. The IoT device that is intruded and/or abnormal is determined based on the situation awareness information. The second indication information is sent to the AF, where the second indication information is used for indicating the IoT device as an IoT device that is intruded and/or abnormal. In an embodiment, the second indication information may be further used for indicating at least one of the following: a time of the IoT device to attack a network, an attack behavior of the IoT device when the IoT device attacks the network.

It should be noted that those skilled in the art may understand that the methods provided in the embodiments of the present disclosure may be performed individually or in combination with some methods in the embodiments of the present disclosure or some methods in the related arts.

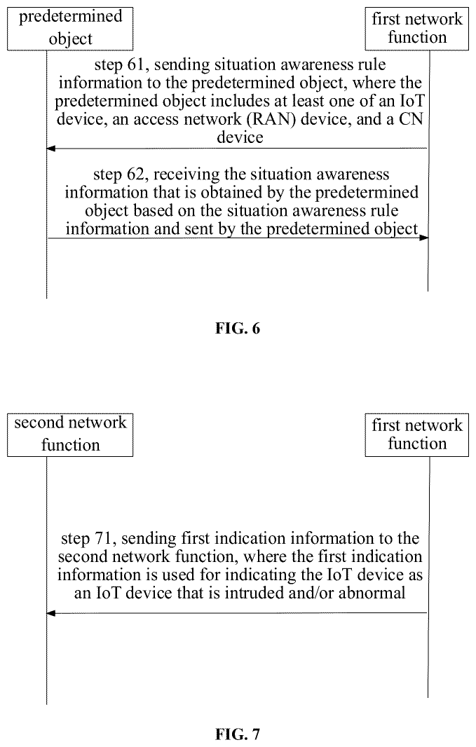

As shown in FIG. 6, a situation awareness processing method is provided in this embodiment, where the method is performed by a first network function, and the method includes steps 61 to 62.

At step 61, situation awareness rule information is sent to a predetermined object, where the predetermined object includes at least one of the following: an IoT device, an access network (RAN) device, and a CN device.

At step 62, situation awareness information that is obtained by the predetermined object based on the situation awareness rule information and sent by the predetermined object is received.

In an embodiment, the situation awareness information includes at least one of the following:
behavior information of an IoT device;
information for sending a data packet; and
information for receiving a data packet.

In an embodiment, the situation awareness rule information is sent to the predetermined object. Request information is sent to the predetermined object, where the request information is used for requesting the situation awareness information. The situation awareness information that is obtained by the predetermined object based on the situation awareness rule information and sent by the predetermined object is received. The IoT device that is intruded and/or abnormal is determined based on the situation awareness information.

In an embodiment, the situation awareness rule information is sent to the predetermined object. Request information is sent periodically to the predetermined object, where the request information is used for requesting the situation awareness information. The situation awareness information that is obtained by the predetermined object based on the situation awareness rule information and sent by the predetermined object is received periodically. The IoT device that is intruded and/or abnormal is determined based on the situation awareness information.

In an embodiment, the situation awareness information sent by the predetermined object is received, where the predetermined object includes at least one of the following: an IoT device, an access network (RAN) device, and a CN device; an IoT device that is intruded and/or abnormal is determined based on the situation awareness information; and first indication information is sent to a second network function, where the first indication information is used for indicating the IoT device as an IoT device that is intruded and/or abnormal, or, second indication information is sent to an AF, where the second indication information is used for indicating the IoT device as an IoT device that is intruded and/or abnormal.

It should be noted that those skilled in the art may understand that the methods provided in the embodiments of the present disclosure may be performed individually or in combination with some methods in the embodiments of the present disclosure or some methods in the related arts.

As shown in FIG. 7, a situation awareness processing method is provided in this embodiment, where the method is performed by a first network function, and the method includes step 71.

At step 71, first indication information is sent to a second network function, where the first indication information is used for indicating an IoT device as an IoT device that is intruded and/or abnormal.

In an embodiment, the first network function is an SATE.

In an embodiment, the first network function is an SATE, and the second network function is a UDM.

In an embodiment, the IoT device that is intruded and/or abnormal is determined based on situation awareness information. In response to determining the IoT device, the first indication information is sent to the second network function, where the first indication information is used for indicating the IoT device as an IoT device that is intruded and/or abnormal. Herein, the first indication information may be used for indicating a device ID of the IoT device.

In an embodiment, the IoT device that is intruded and/or abnormal is determined periodically based on the situation awareness information. In response to determining the IoT device, the first indication information is sent to the second network function, where the first indication information is used for indicating the IoT device as an IoT device that is intruded and/or abnormal. Herein, the first indication information may be used for indicating a device ID of the IoT device.

In an embodiment, the first indication information is used for indicating a device ID of the IoT device. Herein, the ID may be a subscription permanent identifier (SUPI).

In an embodiment, the situation awareness information sent by a predetermined object is received, where the predetermined object includes at least one of the following: an IoT device, an access network (RAN) device, and a CN device; an IoT device that is intruded and/or abnormal is determined based on the situation awareness information; and the first indication information is sent to the second network function, where the first indication information is used for indicating the IoT device as an IoT device that is intruded and/or abnormal, or, second indication information is sent to an AF, where the second indication information is used for indicating the IoT device as an IoT device that is intruded and/or abnormal.

It should be noted that those skilled in the art may understand that the methods provided in the embodiments of the present disclosure may be performed individually or in combination with some methods in the embodiments of the present disclosure or some methods in the related arts.

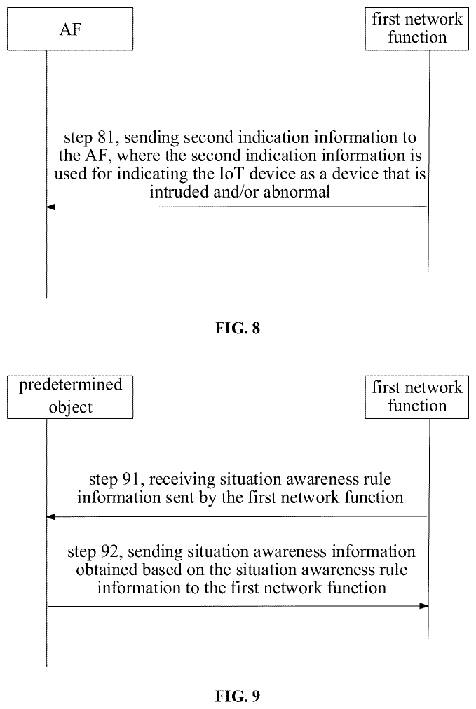

As shown in FIG. 8, a situation awareness processing method is provided in this embodiment, where the method is performed by a first network function, and the method includes step 81.

At step 81, second indication information is sent to an AF, where the second indication information is used for indicating an IoT device as a device that is intruded and/or abnormal.

In an embodiment, the first network function is an SATE.

In an embodiment, the IoT device that is intruded and/or abnormal is determined based on situation awareness information. In response to determining the IoT device, the second indication information is sent to the AF, where the second indication information is used for indicating the IoT device as a device that is intruded and/or abnormal. Herein, the second indication information may be used for indicating a device ID of the IoT device.

In an embodiment, the IoT device that is intruded and/or abnormal is determined periodically based on the situation awareness information. In response to determining the IoT device, the second indication information is sent to the AF, where the second indication information is used for indicating the IoT device as a device that is intruded and/or abnormal. Herein, the second indication information may be used for indicating a device ID of the IoT device.

In an embodiment, the second indication information is used for indicating a device ID of the IoT device. Herein, the ID may be an SUPI.

In an embodiment, the second indication information is used for indicating at least one of the following: a time of the IoT device to attack a network, and an attack behavior of the IoT device when the IoT device attacks the network.

In an embodiment, the situation awareness information sent by a predetermined object is received, where the predetermined object includes at least one of the following: an IoT device, an access network (RAN) device, and a CN device; an IoT device that is intruded and/or abnormal is determined based on the situation awareness information; and first indication information is sent to a second network function, where the first indication information is used for indicating the IoT device as an IoT device that is intruded and/or abnormal, or, the second indication information is sent to the AF, where the second indication information is used for indicating the IoT device as an IoT device that is intruded and/or abnormal.

It should be noted that those skilled in the art may understand that the methods provided in the embodiments of the present disclosure may be performed individually or in combination with some methods in the embodiments of the present disclosure or some methods in the related arts.

As shown in FIG. 9, a situation awareness processing method is provided in this embodiment, where the method is performed by a predetermined object, and the method includes steps 91 to 92.

At step 91, situation awareness rule information sent by a first network function is received.

At step 92, situation awareness information obtained based on the situation awareness rule information is sent to the first network function.

Herein, the IoT device involved in the present disclosure may be a terminal. The terminal may be, but is not limited to, a mobile phone, a wearable device, a vehicle-mounted terminal, an RSU, a smart home terminal, an industrial sensing device, and/or a medical device, etc. In some embodiments, the terminal may be a Redcap terminal or an NR terminal (e.g., an NR terminal of R17) of a predetermined release.

The access network involved in the present disclosure may include a base station. The base station may be of various types, e.g., a base station of a 3G network, a base station of a 4G network, a base station of a 5G network, or other evolved base stations.

The network element involved in the present disclosure may be an AMF, a UDM, and an NEF, etc. The first network function may be an SATE. The second network function may be a UDM. The third network function may be an AMF. It should be noted that the network elements are not limited to the above examples. Exemplarily, the first network function may be any network element with a situation awareness treatment exposure function. In some embodiments of the present disclosure, the network element with the situation awareness treatment exposure function may be deployed as a communication node individually, or may be deployed uniformly within an existing network element. In short, a network element with the situation awareness treatment exposure function may be understood as a logical node that can be flexibly deployed in a network, which is not limited herein.

In an embodiment, the first network function is an SATE.

In an embodiment, the predetermined object includes at least one of the following: an IoT device, an access network (RAN) device, and a CN device.

In an embodiment, the situation awareness information includes at least one of the following:
behavior information of an IoT device;
information for sending a data packet; and
information for receiving a data packet.

In an embodiment, the situation awareness rule information sent by the first network function is received. Request information sent by the first network function is received, where the request information is used for requesting the situation awareness information. The situation awareness information is obtained based on the situation awareness rule information. The situation awareness information is sent to the first network function.

In an embodiment, the situation awareness rule information sent by the first network function is received. Request information sent by the first network function is received periodically, where the request information is used for requesting the situation awareness information. The situation awareness information is obtained periodically based on the situation awareness rule information. The situation awareness information is sent to the first network function periodically.

It should be noted that those skilled in the art may understand that the methods provided in the embodiments of the present disclosure may be performed individually or in combination with some methods in the embodiments of the present disclosure or some methods in the related arts.

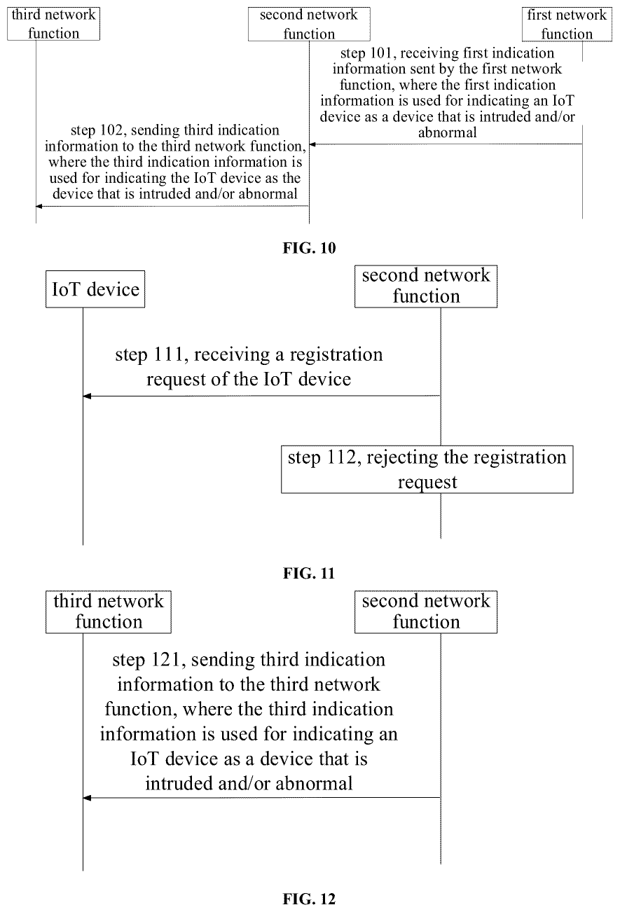

As shown in FIG. 10, a situation awareness processing method is provided in this embodiment, where the method is performed by a second network function, and the method includes steps 101 to 102.

At step 101, first indication information sent by a first network function is received, where the first indication information is used for indicating an IoT device as a device that is intruded and/or abnormal.

At step 102, third indication information is sent to a third network function, where the third indication information is used for indicating the IoT device as the device that is intruded and/or abnormal.

Herein, the IoT device involved in the present disclosure may be a terminal. The terminal may be, but is not limited to, a mobile phone, a wearable device, a vehicle-mounted terminal, an RSU, a smart home terminal, an industrial sensing device, and/or a medical device, etc. In some embodiments, the terminal may be a Redcap terminal or an NR terminal (e.g., an NR terminal of R17) of a predetermined release.

The access network involved in the present disclosure may include a base station. The base station may be of various types, e.g., a base station of a 3G network, a base station of a 4G network, a base station of a 5G network, or other evolved base stations.

The network element involved in the present disclosure may be an AMF, a UDM, and an NEF, etc. The first network function may be an SATE. The second network function may be a UDM. The third network function may be an AMF. It should be noted that the network elements are not limited to the above examples. Exemplarily, the first network function may be any network element with a situation awareness treatment exposure function. In some embodiments of the present disclosure, the network element with the situation awareness treatment exposure function may be deployed as a communication node individually, or may be deployed uniformly within an existing network element. In short, a network element with the situation awareness treatment exposure function may be understood as a logical node that can be flexibly deployed in a network, which is not limited herein.

In an embodiment, the first network function is an SATE; the second network function is a UDM; and the third network function is an AMF.

In an embodiment, the first indication information sent by the first network function is received, where the first indication information indicates an IoT device as a device that is intruded and/or abnormal. The third indication information is sent to the third network function, where the third indication information is used for indicating the IoT device as the device that is intruded and/or abnormal. Herein, the first indication information may be used for indicating a device ID of the IoT device. The third indication information is used for indicating a device identification of the IoT device.

In an embodiment, the first indication information sent by the first network function is received periodically, where the first indication information indicates an IoT device as a device that is intruded and/or abnormal. The third indication information is sent periodically to the third network function, where the third indication information is used for indicating the IoT device as the device that is intruded and/or abnormal.

The first indication information sent by the first network function is received, where the first indication information is used for indicating an IoT device as a device that is intruded and/or abnormal. A state of the IoT device is set and/or stored based on an abnormity identification.

In an embodiment, the first indication information sent by the first network function is received, where the first indication information is used for indicating an IoT device as a device that is intruded and/or abnormal. A state of the IoT device is set and/or stored based on an abnormity identification. A registration request of the IoT device is received; and the registration request is rejected.

It should be noted that those skilled in the art may understand that the methods provided in the embodiments of the present disclosure may be performed individually or in combination with some methods in the embodiments of the present disclosure or some methods in the related arts.

As shown in FIG. 11, a situation awareness processing method is provided in this embodiment, where the method is performed by a second network function, and the method includes steps 111 to 112.

At step 111, a registration request of an IoT device is received.

At step 112, the registration request is rejected.

In an embodiment, the second network function is a UDM.

In an embodiment, first indication information sent by a first network function is received, where the first indication information is used for indicating an IoT device as a device that is intruded and/or abnormal. A state of the IoT device is set and/or stored based on an abnormity identification. The registration request of the IoT device is received; and the registration request is rejected in response to determining that the IoT device is a device indicated by the first indication information. Herein, the rejection of the registration request may be to prohibit the IoT device from accessing the IoT.

It should be noted that those skilled in the art may understand that the methods provided in the embodiments of the present disclosure may be performed individually or in combination with some methods in the embodiments of the present disclosure or some methods in the related arts.

As shown in FIG. 12, a situation awareness processing method is provided in this embodiment, where the method is performed by a second network function, and the method includes step 121.

At step 121, third indication information is sent to a third network function, where the third indication information is used for indicating an IoT device as a device that is intruded and/or abnormal.

In an embodiment, the second network function is a UDM; and the third network function is an AMF.

In an embodiment, first indication information sent by a first network function is received, where the first indication information is used for indicating an IoT device as a device that is intruded and/or abnormal. The third indication information is sent to the third network function, where the third indication information is used for indicating the IoT device as the device that is intruded and/or abnormal. Herein, the third indication information is used for indicating a device identification of the IoT device.

In an embodiment, the first indication information sent by the first network function is received, where the first indication information is used for indicating an IoT device as a device that is intruded and/or abnormal. A state of the IoT device is set and/or stored based on an abnormity identification. The third indication information is sent to the third network function, where the third indication information is used for indicating the IoT device as the device that is intruded and/or abnormal.

It should be noted that those skilled in the art may understand that the methods provided in the embodiments of the present disclosure may be performed individually or in combination with some methods in the embodiments of the present disclosure or some methods in the related arts.

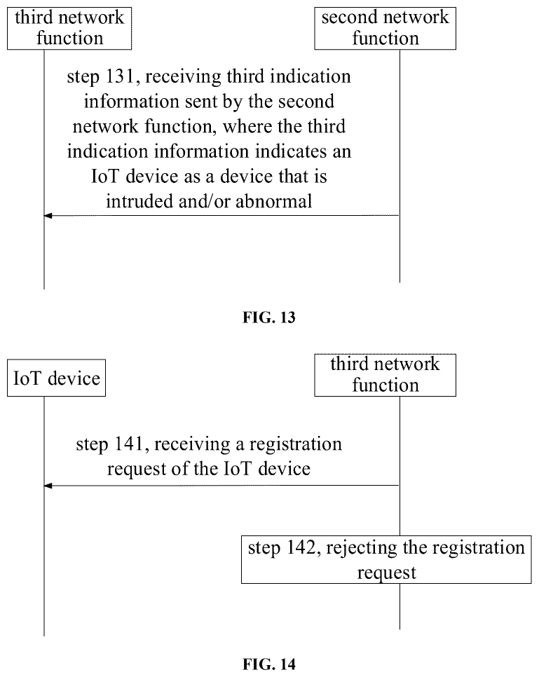

As shown in FIG. 13, a situation awareness processing method is provided in this embodiment, where the method is performed by a third network function, and the method includes step 131.

At step 131, third indication information sent by a second network function is received, where the third indication information indicates an IoT device as a device that is intruded and/or abnormal.

Herein, the IoT device involved in the present disclosure may be a terminal. The terminal may be, but is not limited to, a mobile phone, a wearable device, a vehicle-mounted terminal, an RSU, a smart home terminal, an industrial sensing device, and/or a medical device, etc. In some embodiments, the terminal may be a Redcap terminal or an NR terminal (e.g., an NR terminal of R17) of a predetermined release.

The access network involved in the present disclosure may include a base station. The base station may be of various types, e.g., a base station of a 3G network, a base station of a 4G network, a base station of a 5G network, or other evolved base stations.

The network element involved in the present disclosure may be an AMF, a UDM, and an NEF, etc. The first network function may be an SATE, the second network function may be a UDM, and the third network function may be an AMF. It should be noted that the network elements are not limited to the above examples. Exemplarily, the first network function may be any network element with a situation awareness treatment exposure function. In some embodiments of the present disclosure, the network element with the situation awareness treatment exposure function may be deployed as a communication node individually, or may be deployed uniformly within an existing network element. In short, a network element with the situation awareness treatment exposure function may be understood as a logical node that can be flexibly deployed in a network, which is not limited herein.

In an embodiment, the third indication information sent by the second network function is received, where the third indication information indicates an IoT device as a device that is intruded and/or abnormal. A state of the IoT device is set and/or stored based on an abnormity identification. Herein, the third indication information may indicate a device identification of the IoT device.

In an embodiment, the third indication information sent by the second network function is received, where the third indication information indicates an IoT device as a device that is intruded and/or abnormal. A registration request of the IoT device is received; and the registration request is rejected.

In an embodiment, the third indication information sent by the second network function is received, where the third indication information indicates an IoT device as a device that is intruded and/or abnormal. A state of the IoT device is set and/or stored based on an abnormity identification. A registration request of the IoT device is received; and the registration request is rejected.

In an embodiment, the third indication information sent by the second network function is received, where the third indication information indicates an IoT device as a device that is intruded and/or abnormal. The IoT device is deregistered from a network.

In an embodiment, the third indication information sent by the second network function is received, where the third indication information indicates an IoT device as a device that is intruded and/or abnormal. A state of the IoT device is set and/or stored based on an abnormity identification. The IoT device is deregistered from a network.

It should be noted that those skilled in the art may understand that the methods provided in the embodiments of the present disclosure may be performed individually or in combination with some methods in the embodiments of the present disclosure or some methods in the related arts.

As shown in FIG. 14, a situation awareness processing method is provided in this embodiment, where the method is performed by a third network function, and the method includes steps 141 to 142.

At step 141, a registration request of an IoT device is received.

At step 142, the registration request is rejected.

In an embodiment, third indication information sent by a second network function is received, where the third indication information indicates an IoT device as a device that is intruded and/or abnormal. The registration request of the IoT device is received; and the registration request is rejected.

In an embodiment, the third indication information sent by the second network function is received, where the third indication information indicates an IoT device as a device that is intruded and/or abnormal. A state of the IoT device is set and/or stored based on an abnormity identification. The registration request of the IoT device is received; and the registration request is rejected.

It should be noted that those skilled in the art may understand that the methods provided in the embodiments of the present disclosure may be performed individually or in combination with some methods in the embodiments of the present disclosure or some methods in the related arts.

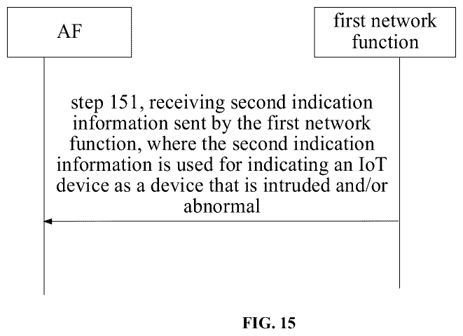

As shown in FIG. 15, a situation awareness processing method is provided in this embodiment, where the method is performed by an AF, and the method includes step 151.

At step 151, second indication information sent by a first network function is received, where the second indication information is used for indicating an IoT device as a device that is intruded and/or abnormal.

Herein, the IoT device involved in the present disclosure may be a terminal. The terminal may be, but is not limited to, a mobile phone, a wearable device, a vehicle-mounted terminal, an RSU, a smart home terminal, an industrial sensing device, and/or a medical device, etc. In some embodiments, the terminal may be a Redcap terminal or an NR terminal (e.g., an NR terminal of R17) of a predetermined release.

The access network involved in the present disclosure may include a base station. The base station may be of various types, e.g., a base station of a 3G network, a base station of a 4G network, a base station of a 5G network, or other evolved base stations.

The network element involved in the present disclosure may be an AMF, a UDM, and an NEF, etc. The first network function may be an SATE, the second network function may be a UDM, and the third network function may be an AMF. It should be noted that the network elements are not limited to the above examples. Exemplarily, the first network function may be any network element with a situation awareness treatment exposure function. In some embodiments of the present disclosure, the network element with the situation awareness treatment exposure function may be deployed as a communication node individually, or may be deployed uniformly within an existing network element. In short, a network element with the situation awareness treatment exposure function may be understood as a logical node that can be flexibly deployed in a network, which is not limited herein.

In an embodiment, a situation awareness service of the IoT device is subscribed to. The second indication information sent by the first network function is received, where the second indication information is used for indicating an IoT device as a device that is intruded and/or abnormal. Herein, the second indication information is used for indicating at least one of the following: a time of the IoT device to attack a network, and an attack behavior of the IoT device when the IoT device attacks the network. Herein, the time of attacking the network may be a time point for attacking the network, or a duration for attacking the network.

It should be noted that those skilled in the art may understand that the methods provided in the embodiments of the present disclosure may be performed individually or in combination with some methods in the embodiments of the present disclosure or some methods in the related arts.

In order to better understand the technical solutions of the present disclosure, the technical solutions of the present disclosure are exemplarily described below by using three exemplary embodiments.

### Example 1

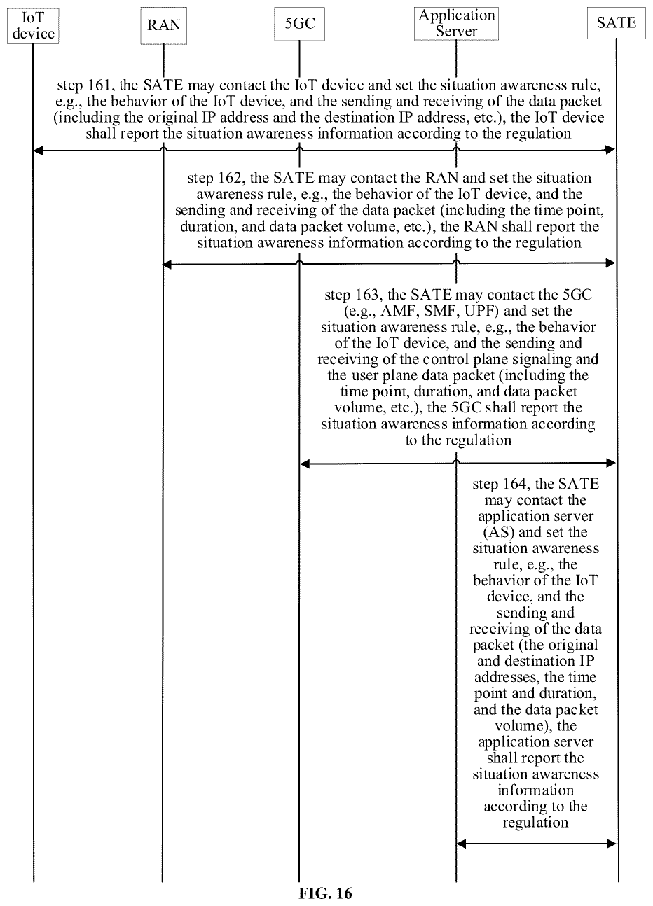

Referring to FIG. 16, a situation awareness processing method is provided, where the method includes at least one of the following steps 161 to 164.

At step 161, the SATE may contact the IoT device and set the situation awareness rule, e.g., the behavior of the IoT device, and the sending and receiving of the data packet (including the original IP address and the destination IP address, etc.). The IoT device shall report the situation awareness information according to the regulation.

At step 162, the SATE may contact the RAN and set the situation awareness rule, e.g., the behavior of the IoT device, and the sending and receiving of the data packet (including the time point, duration, and data packet volume, etc.). The RAN shall report the situation awareness information according to the regulation.

At step 163, the SATE may contact the 5GC (e.g., AMF, SMF, UPF) and set the situation awareness rule, e.g., the behavior of the IoT device, and the sending and receiving of the control plane signaling and the user plane data packet (including the time point, duration, and data packet volume, etc.). The 5GC shall report the situation awareness information according to the regulation.

At step 164, the SATE may contact the application server (AS) and set the situation awareness rule, e.g., the behavior of the IoT device, and the sending and receiving of the data packet (the original and destination IP addresses, the time point and duration, and the data packet volume). The application server shall report the situation awareness information according to the regulation.

### Example 2

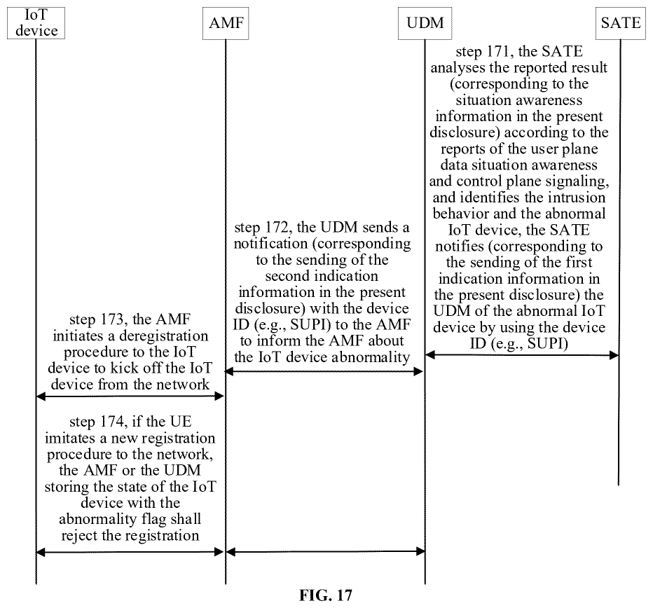

Referring to FIG. 17, a situation awareness processing method is provided, where the method includes steps 171 to 174.

At step 171, the SATE analyses the reported result (corresponding to the situation awareness information in the present disclosure) according to the reports of the user plane data situation awareness and control plane signaling, and identifies the intrusion behavior and the abnormal IoT device. The SATE notifies (corresponding to the sending of the first indication information in the present disclosure) the UDM of the abnormal IoT device by using the device ID (e.g., SUPI). The UDM sets and stores the state of the IoT device by using the abnormality flag.

At step 172, the UDM sends a notification (corresponding to the sending of the second indication information in the present disclosure) with the device ID (e.g., SUPI) to the AMF to inform the AMF about the IoT device abnormality. The AMF may set and store the state of the IoT device with the abnormality flag.

At step 173, the AMF initiates a deregistration procedure to the IoT device to kick off the IoT device from the network.

At step 174, if the UE imitates a new registration procedure to the network, the AMF or the UDM storing the state of the IoT device with the abnormality flag shall reject the registration.

### Example 3

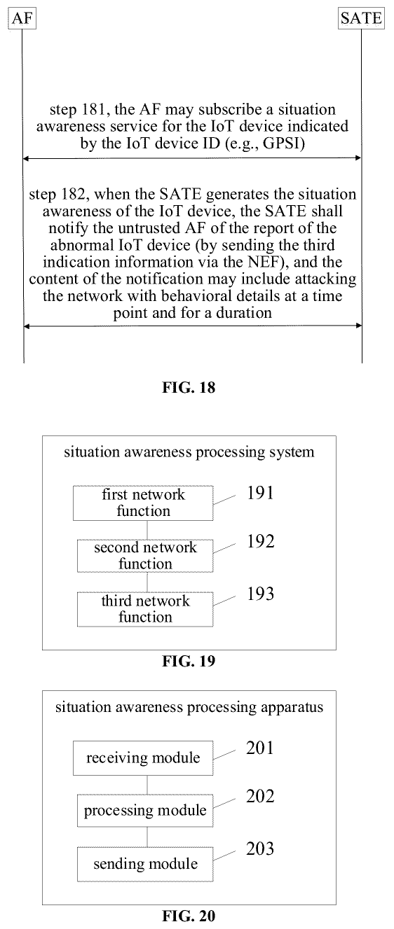

Referring to FIG. 18, a situation awareness processing method is provided, where the method includes steps 181 to 182.

At step 181, the AF may subscribe a situation awareness service for the IoT device indicated by the IoT device ID (e.g., GPSI).

At step 182, when the SATE generates the situation awareness of the IoT device, the SATE shall notify the untrusted AF of the report of the abnormal IoT device (by sending the third indication information via the NEF), and the content of the notification may include attacking the network with behavioral details at a time point and for a duration.

It should be noted that those skilled in the art may understand that the methods provided in the embodiments of the present disclosure may be performed individually or in combination with some methods in the embodiments of the present disclosure or some methods in the related arts.

As shown in FIG. 19, a situation awareness processing system is provided in this embodiment, where the system includes a first network function 191, a second network function 192 and a third network function 193. The first network function performs the method as performed by any first network function of the present disclosure; the second network function performs the method as performed by any second network function of the present disclosure; and the third network function performs the method as performed by any third network function of the present disclosure.

It should be noted that those skilled in the art may understand that the methods provided in the embodiments of the present disclosure may be performed individually or in combination with some methods in the embodiments of the present disclosure or some methods in the related arts.

As shown in FIG. 20, a situation awareness processing apparatus is provided in the embodiments of the present disclosure, where the apparatus includes:
a receiving module 201, configured to receive situation awareness information sent by a predetermined object;
a processing module 202, configured to determine, based on the situation awareness information, an IoT device that is intruded and/or abnormal; and
a sending module 203, configured to send first indication information to a second network function, where the first indication information is used for indicating the IoT device as an IoT device that is intruded and/or abnormal.

It should be noted that those skilled in the art may understand that the methods provided in the embodiments of the present disclosure may be performed individually or in combination with some methods in the embodiments of the present disclosure or some methods in the related arts.

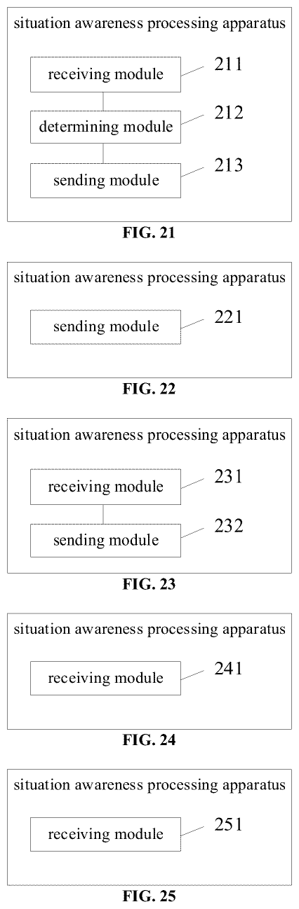

As shown in FIG. 21, a situation awareness processing apparatus is provided in the embodiments of the present disclosure, where the apparatus includes:
a receiving module 211, configured to receive situation awareness information sent by a predetermined object;
a determining module 212, configured to determine, based on the situation awareness information, an IoT device that is intruded and/or abnormal; and
a sending module 213, configured to send second indication information to an AF, where the second indication information is used for indicating the IoT device as an IoT device that is intruded and/or abnormal.

It should be noted that those skilled in the art may understand that the methods provided in the embodiments of the present disclosure may be performed individually or in combination with some methods in the embodiments of the present disclosure or some methods in the related arts.

As shown in FIG. 22, a situation awareness processing apparatus is provided in the embodiments of the present disclosure, where the apparatus includes:
a sending module 221, configured to send situation awareness information obtained based on situation awareness rule information to a first network function.

It should be noted that those skilled in the art may understand that the methods provided in the embodiments of the present disclosure may be performed individually or in combination with some methods in the embodiments of the present disclosure or some methods in the related arts.

As shown in FIG. 23, a situation awareness processing apparatus is provided in the embodiments of the present disclosure, where the apparatus includes:
a receiving module 231, configured to receive first indication information sent by a first network function, where the first indication information is used for indicating an IoT device as a device that is intruded and/or abnormal; and
a sending module 232, configured to send third indication information to a third network function, where the third indication information is used for indicating the IoT device as the device that is intruded and/or abnormal.

It should be noted that those skilled in the art may understand that the methods provided in the embodiments of the present disclosure may be performed individually or in combination with some methods in the embodiments of the present disclosure or some methods in the related arts.

As shown in FIG. 24, a situation awareness processing apparatus is provided in the embodiments of the present disclosure, where the apparatus includes:
a receiving module 241, configured to receive third indication information sent by a second network function, where the third indication information is used for indicating an IoT device as a device that is intruded and/or abnormal.

It should be noted that those skilled in the art may understand that the methods provided in the embodiments of the present disclosure may be performed individually or in combination with some methods in the embodiments of the present disclosure or some methods in the related arts.

As shown in FIG. 25, a situation awareness processing apparatus is provided in the embodiments of the present disclosure, where the apparatus includes:
a receiving module 251, configured to receive second indication information sent by a first network function; where
the second indication information is used for indicating an IoT device as a device that is intruded and/or abnormal.

It should be noted that those skilled in the art may understand that the methods provided in the embodiments of the present disclosure may be performed individually or in combination with some methods in the embodiments of the present disclosure or some methods in the related arts.

The embodiments of the present disclosure provide a communication device, where the communication device includes:
a processor; and
a memory, configured to store an executable instruction of the processor; where
the processor, when running the executable instruction, is configured to implement the method applied to any embodiment of the present disclosure.

In some embodiments, the processor may include various types of storage media, where the storage media are non-transitory computer storage media capable of continuing to memorize information stored therein after the communication device is powered down.

The processor may be connected to the memory via a bus or the like for reading an executable program stored in the memory.

The embodiments of the present disclosure also provide a computer storage medium, where the computer storage medium stores a computer-executable program, and the executable program, when executed by a processor, implements the method of any embodiment of the present disclosure.

With respect to the apparatus in the above embodiments, the specific manner in which each module performs an operation has been described in detail in the embodiments relating to the method, and will not be described in detail here.

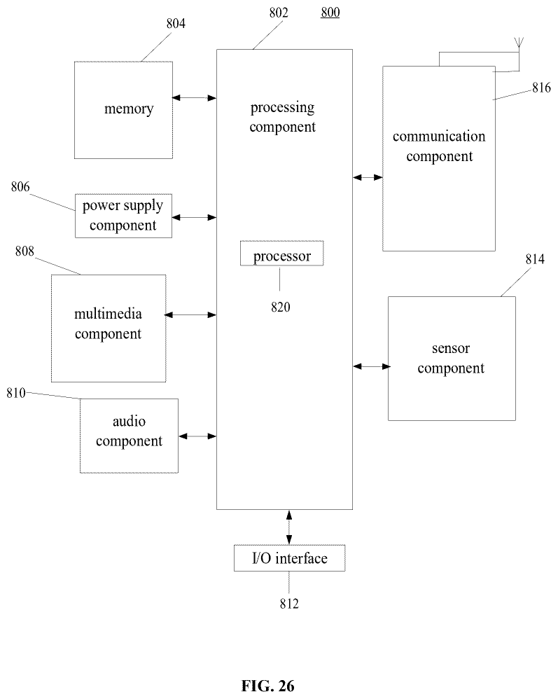

As shown in FIG. 26, an embodiment of the present disclosure provides a structure of a terminal.

Referring to the terminal 800 shown in FIG. 26, this embodiment provides a terminal 800, where the terminal may specifically be a mobile phone, a computer, a digital broadcast terminal, a message transceiver device, a game console, a tablet device, a medical device, a fitness device, or a personal digital assistant, etc.

Referring to FIG. 26, the terminal 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the terminal 800, such as operations associated with display, telephone calls, data communication, camera operations, and recording operations. The processing component 802 may include one or more processors 820 to execute an instruction to complete all or part of the steps of the method described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operations on the device 800. Examples of such data include the following: an instruction of any application program or method operated on the terminal 800, contact data, phonebook data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 806 supplies power to various components of the terminal 800. The power supply component 806 may include a power supply management system, one or more power supplies, and other components associated with generating, managing and distributing power for the terminal 800.

The multimedia component 808 includes a screen that provides an output interface between the terminal 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In some embodiments, the multimedia component 808 includes a front-facing camera and/or a rear-facing camera. The front-facing camera and/or the rear-facing camera may receive external multimedia data when the device 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the terminal 800 is in an operating mode, such as a calling mode, a recording mode and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module described above may be a keypad, a click wheel, a button, etc. These buttons may include, but are not limited to, a home button, a volume button, a start button, and a lock button.

The sensor component 814 includes one or more sensors configured to provide state assessment of various aspects of the terminal 800. For example, the sensor component 814 may detect an open/closed state of the device 800, and relative positioning of the components, for example, the components are the display and small keypad of the terminal 800. The sensor component 814 may also detect a change in the position of the terminal 800 or a change in the position of a component of the terminal 800, the presence or absence of contact between the user and the terminal 800, the orientation or acceleration/deceleration of terminal 800, and temperature changes of the terminal 800. The sensor component 814 may include a proximity sensor that is configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the terminal 800 and other devices in wired or wireless manners. The terminal 800 may access a wireless network based on a communication standard, such as Wi-Fi, 2G, 3G, or a combination thereof. In an exemplary embodiment, the communication component 816 receives broadcast signals or broadcast related information from an external broadcast management system via a broadcast channel. In an exemplary embodiment, the communication component 816 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the Bluetooth (BT) technology, or other technologies.

In an exemplary embodiment, the terminal 800 may be implemented by one or more of the following: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the method described above.

In an exemplary embodiment, a non-transitory computer-readable storage medium including an instruction is provided, such as the memory 804 including an instruction. The instruction described above is capable of being executed by the processor 820 of the terminal 800 to generate the method described above. For example, the non-transitory computer-readable storage medium may be an ROM, a random access memory (RAM), a CD-ROM, a magnetic tape, a floppy disk, or an optical data storage device.

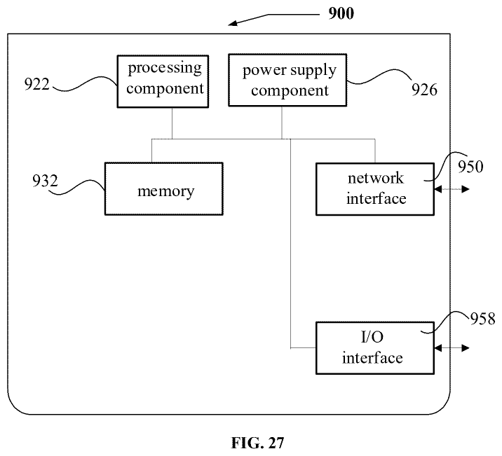

As shown in FIG. 27, an embodiment of the present disclosure illustrates a structure of a base station. For example, the base station 900 may be provided as a network side device. Referring to FIG. 27, the base station 900 includes a processing component 922, where the processing component 922 further includes one or more processors, and a memory resource represented by a memory 932 for storing an instruction, such as an application program, that is executable by the processing component 922. The application program stored in the memory 932 may include one or more modules each corresponding to a set of instructions. In addition, the processing component 922 is configured to execute the instruction to perform any method described above applied to the base station.

The base station 900 may further include a power supply component 926 configured to perform power management of the base station 900, a wired or wireless network interface 950 configured to connect the base station 900 to the network, and an I/O interface 958. The base station 900 may operate an operating system stored in the memory 932, such as Windows Server™, Mac OS X™, Unix™, Linux™, FreeBSD™, or the like.

After considering the specification and practicing the invention disclosed herein, those skilled in the art will easily come up with other implementation solutions of the present invention. The present disclosure is intended to cover any variations, uses or adaptive changes of the present invention, and the variations, uses or adaptive changes follow the general principles of the present invention and include common knowledge or commonly used technical means in the technical field that is not disclosed in the present disclosure. The specification and embodiments are only considered to be exemplary, and the true scope and spirit of the present invention are indicated by the following claims.

It should be understood that the present invention is not limited to the precise structure which has been described above and illustrated in the accompanying drawings, and that various modifications and alterations may be made without departing from the scope of the present invention. The scope of the present invention is limited only by the appended claims.

1. A situation awareness processing method, performed by a first network function, comprising:
receiving situation awareness information sent by a predetermined object;
determining, based on the situation awareness information, an Internet of Things (IoT) device that is at least one of being intruded or abnormal; and
sending first indication information to a second network function, wherein the first indication information is used for indicating the IoT device as an IoT device that is at least one of being intruded or abnormal.

2. The method according to claim 1, wherein the first network function is a situation awareness treatment exposure function (SATE).

3. The method according to claim 1, further comprising:
sending situation awareness rule information to the predetermined object; wherein
the receiving the situation awareness information sent by the predetermined object comprises:
receiving the situation awareness information that is obtained by the predetermined object based on the situation awareness rule information and sent by the predetermined object.

4. The method according to claim 1, wherein the situation awareness information comprises at least one of:
behavior information of an IoT device;
information for sending a data packet; or
information for receiving a data packet.

5. The method according to claim 1, wherein the second network function is a unified data management (UDM).

6. The method according to claim 1, wherein the first indication information is further used for indicating a device identification (ID) of the IoT device.

7. The method according to claim 1, further comprising:
sending second indication information to an application function (AF), wherein the second indication information is used for indicating the IoT device as the IoT device that is at least one of being intruded or abnormal.

8-11. (canceled)

12. A situation awareness processing method, performed by a predetermined object, comprising:
sending situation awareness information to a first network function, wherein the situation awareness information is used for determining an Internet of Things (IoT) device that is at least one of being intruded or abnormal.

13. The method according to claim 12, further comprising:
receiving situation awareness rule information sent by the first network function; and
obtaining the situation awareness information based on the situation awareness rule information.

14. The method according to claim 12, wherein the first network function is a situation awareness treatment exposure function (SATE).

15. The method according to claim 12, wherein the situation awareness information comprises at least one of:
behavior information of an IoT device;
information for sending a data packet; or
information for receiving a data packet.

16. A situation awareness processing method, performed by a second network function, comprising:
receiving first indication information sent by a first network function, wherein the first indication information is used for indicating an Internet of Things (IoT) device as a device that is at least one of being intruded or abnormal; and
sending third indication information to a third network function, wherein the third indication information is used for indicating the IoT device as the device that is at least one of being intruded or abnormal.

17. The method according to claim 16, wherein the first network function is a situation awareness treatment exposure function (SATE), and the second network function is a unified data management (UDM).

18. The method according to claim 16, wherein the first indication information is further used for indicating a device identification (ID) of the IoT device.

19. The method according to claim 16, further comprising:
setting and/or storing a state of the IoT device based on an abnormity identification.

20. The method according to claim 19, further comprising:
receiving a registration request of the IoT device; and
rejecting the registration request.

21. The method according to claim 16, wherein the third network function is an access and mobility management function (AMF).

22. The method according to claim 16, wherein the third indication information is used for indicating a device identification of the IoT device.

23-39. (canceled)

40. A communication device, comprising:
an antenna;
a memory, storing a computer-executable instruction; and
a processor, connected to the antenna and the memory respectively, wherein the processor, through executing the computer-executable instruction stored in the memory, is configured to control receiving and sending of the antenna, and perform the method according to claim 1.

41. A non-transitory computer storage medium, storing a computer-executable instruction, wherein the computer-executable instruction, when executed by a processor, causes the processor to perform the method according to claim 1.
